(19) United States
(12) Patent Application Publication
(10) Pub. No.: US 2007/0234425 A1
(43) Pub. Date: Oct. 4, 2007

(54) Multistep integrated security management system and method using intrusion detection log collection engine and traffic statistic generation engine

(76) Inventors: Woonyon Kim, Daejeon (KR); Eun Young Lee, Daejeon (KR); Sang Hoon Lee, Daejeon (KR); Dong Su Nam, Seoul (KR); Joo Beom Yun, Daejeon (KR); Jong Moon Lee, Daejeon (KR); Miri Joo, Daejeon (KR); Dohoon Lee, Daejeon (KR); Eungki Park, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/453,497

(22) Filed: Jun. 15, 2006

(30) Foreign Application Priority Data
Mar. 29, 2006 (KR) 2006-28232

(51) Int. Cl. G06F 12/14

(52) U.S. Cl. 726/23

(57) ABSTRACT

A multistep integrated security management system and method using an intrusion detection log collection engine and a traffic statistic generation engine is disclosed. An intrusion detection log collection engine capable of collecting logs generated from diverse intrusion detection engines and a traffic statistic generation engine collect and transmit analyzed data to a control intermediate management server. The control intermediate management server performs more accurate intrusion detection by relationally analyzing the intrusion detection log information and the traffic statistic information. A control uppermost management server performs an integrated security management on a large-scale group subject to control by performing an integrated analysis on a large-scale group subject to control, and thus can support the large-scale integrated security management efficiently.

### BACKGROUND OF THE INVENTION

1. Field of the Invention

The present invention relates to a security management system and method, and more particularly to a multistep integrated security management system and method using an intrusion detection log collection engine and a traffic statistic generation engine, which monitors an external intrusion by relationally analyzing intrusion detection log information and traffic statistic information collected using the intrusion detection log collection engine for collecting logs of an intrusion detection system and the traffic statistic generation engine for generating the traffic statistic information, and supports a multistep structure for a large-scale control.

2. Background of the Related Art

With the rapid growth of Internet, it provides diverse advantages, but includes many problems. The biggest problem among the problems refers to the security. At present, many systems are becoming the subject of attack, and such intrusion behavior is classified into two types: a misuse intrusion and an abnormal intrusion. To cope with this, many intrusion detection techniques have been introduced, and intrusion detection systems (IDS) on which the intrusion detection techniques are mounted have been commercialized. However, most intrusion detection systems adopt pattern detection technique, which causes a high misdetection rate. Accordingly, it causes problems to perform the intrusion detection using the intrusion detection information only.

In the conventional control system using intrusion detection log information, it is difficult to confirm the actual intrusion information due to the frequent misdetection. Accordingly, attempts to detect intrusions using the number of collected intrusion detection logs or the number of logs collected according to detected attack names, or to find the actual attacks using a data mining technique, have been made. However, it is still difficult to detect the attacks.

On the other hand, as attempts to detect external intrusions using a statistic technique, methods using the traffic statistics have been proposed. The methods using the traffic statistics perform the detection of an abnormal state through time series analysis of the traffic statistic information if traffic is abruptly increased or traffic of a specified port is increased. However, these methods may decide a normal state in which a lot of traffic occurs as an attack, and cannot detect an intrusion attempt that causes a small amount of traffic.

Unlike the intrusion detection system, a control system that uses traffic statistic information does not use a specified pattern, and thus provides a scheme for detecting abnormal traffic. Generally, the method using the traffic statistic information judges whether the present state is a normal state or an abnormal state by comparing the traffic statistic value of a normal state with the currently collected traffic statistic value. Since this method also judges the state using the traffic statistic information only, it has a high misdetection rate, and cannot detect an attack if the attack causes a small amount of traffic.

Many control systems have a two-step structure of a control server and an agent. However, this structure is not suitable to perform security control in association with a plurality of independent means.

### SUMMARY OF THE INVENTION

Accordingly, the present invention is directed to a multistep integrated security management system and method using an intrusion detection log collection engine and a traffic statistic generation engine, which substantially obviates one or more problems due to limitations and disadvantages of the related art.

It is an object of the present invention to provide a multistep integrated security management system and method using an intrusion detection log collection engine and a traffic statistic generation engine, which relationally analyzes intrusion detection logs and traffic and thus can reduce a misdetection rate that refers to the drawback of a intrusion detection system for detecting an attack by a predefined pattern system, difficulty in detecting an unknown abnormal attack, difficulty in detecting an attack having a small change of traffic that refers to the drawback of an abnormal detection method using traffic statistics, and a misdetection rate of a statistic scheme.

It is another object of the present invention to provide a multistep integrated security management system and method using an intrusion detection log collection engine and a traffic statistic generation engine, which can control several independent large-scale means by constituting a management server as a multistep hierarchical structure.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

In order to achieve the above object, there is provided a multistep integrated security management system using an intrusion detection log collection engine and a traffic statistic generation engine, according to the present invention, which includes control agents provided for respective means that use independent networks, and each being composed of the intrusion detection log collection engine for collecting intrusion detection logs and the traffic statistic generation engine for generating traffic statistics; and a management server for individually or relationally analyzing the intrusion detection logs and the traffic statistics transferred from the respective control agents, and integrally or relationally analyzing intrusion detection log information and traffic statistic information that are results of the individual or relational analysis.

In another aspect of the present invention, there is provided a multistep integrated security management method using an intrusion detection log collection engine and a traffic statistic generation engine, which includes the steps of the intrusion detection log collection engine collecting intrusion detection logs and the traffic statistic generation engine collecting traffic statistics, for each control agent; transferring the intrusion detection logs and the traffic statistics to control intermediate management servers, and the control intermediate management servers performing individual analysis, and performing relational analysis if the relational analysis is required; and transferring intrusion detection log information and traffic statistic information that are results of the analysis to a control uppermost management server, and the control uppermost management server performing integrated analysis including individual analysis, and performing relational analysis if the relational analysis is required.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view illustrating the entire construction of a system for real-time integrated security management according to an embodiment of the present invention;

FIG. 2 is a view illustrating the internal construction of an intrusion detection log collection engine according to an embodiment of the present invention;

FIG. 3 is a view illustrating the internal construction of a traffic statistic generation engine according to an embodiment of the present invention;

FIG. 4 is a flowchart illustrating a process performed by intrusion detection analysis units and traffic analysis units of a control intermediate management server and a control uppermost management server according to an embodiment of the present invention; and

FIG. 5 is a flowchart illustrating a process performed by relational analysis units of a control intermediate management server and a control uppermost management server according to an embodiment of the present invention.

### DETAILED DESCRIPTION OF THE PREFERRED EMBODIMENT

A multistep integrated security management system and method using an intrusion detection log collection engine and a traffic statistic generation engine according to the preferred embodiment of the present invention will now be explained in detail with reference to the accompanying drawings.

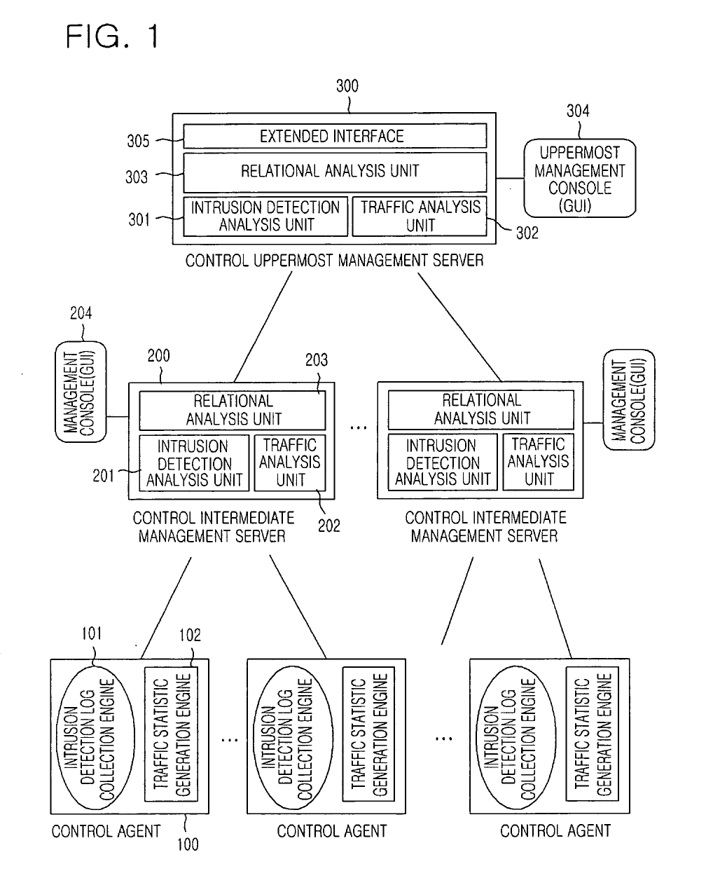

FIG. 1 is a view illustrating the entire construction of a system for real-time integrated security management according to an embodiment of the present invention.

As illustrated in FIG. 1, the multistep integrated security management system using an intrusion detection log collection engine and a traffic statistic generation engine according to the present invention includes control agents 100, control intermediate management servers 200, and a control uppermost management server 300, which are connected together through networks.

The control agent 100 is located in the foremost of a means that uses an independent network, and should exist in a position in which it can observe all network traffics through a switch mirroring or tap equipment. One agent is required for each means that uses an independent network. The control agent is composed of an intrusion detection log collection engine 101 for collecting intrusion detection logs and a traffic statistic generation engine 102 for generating traffic statistics. It is possible to construct two engines in one system or in separate systems.

The control intermediate management server 200 includes an intrusion detection analysis unit 201 for performing individual analysis of information collected by the intrusion detection log collection engines of the control agents 100, a traffic analysis unit 202 for performing individual analysis of information collected by the traffic statistic generation engines, a relational analysis unit 203 for performing a relational analysis of the intrusion detection information and the traffic statistics, and a management console 204 for providing the result of analysis to a manager.

The control intermediate management server 200 can receive and manage the intrusion detection information and the traffic statistic information from various control agents 100, provide analyzed information to the manager, and transmit information collected from the control agents 100 to the control uppermost management server 300, so that the analysis in the uppermost step becomes possible.

The control uppermost management server 300 receives the information transmitted from the various control intermediate management servers 200. The intrusion detection analysis unit 301 performs individual analysis of the intrusion detection information, the traffic analysis unit 302 performs individual analysis of the traffic statistic information, and the relational analysis unit 303 performs relational analysis of the intrusion detection information and the traffic statistic information. The analyzed information is provided to the uppermost manager through the uppermost management console 304. Also, the control uppermost management server provides an extended interface 305 in order to connect to other upper management servers, and all information collected through this interface can be transmitted to other management servers.

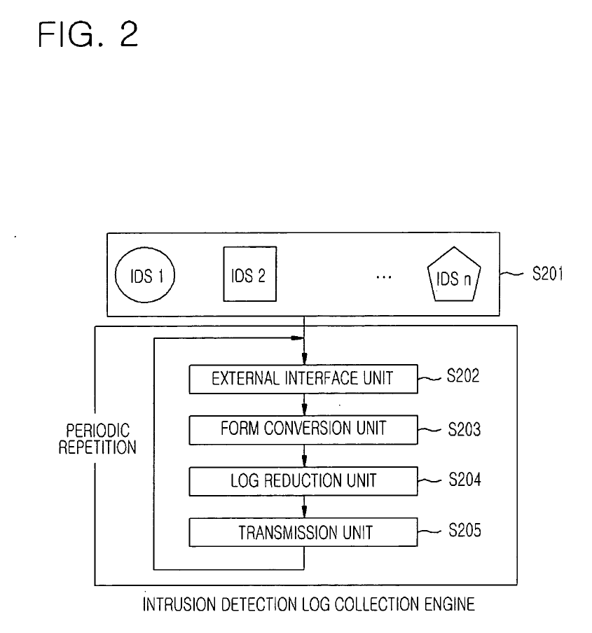

FIG. 2 is a view illustrating the internal construction of an intrusion detection log collection engine according to an embodiment of the present invention.

In FIG. 2, a process of collecting intrusion detection logs, which is performed by the intrusion detection log collection engine 101, is illustrated. For this, the intrusion detection log collection engine includes an external interface unit S201, a form conversion unit S203, a log reduction unit S204, and a transmission unit S205.

The external interface unit S202 is an interface for collecting logs from diverse intrusion detection systems (IDSs) S201, and the intrusion detection log collection engine accesses the intrusion detection logs through the external interface unit.

The form conversion unit S203 serves to convert the intrusion detection logs collected from diverse systems into a form that is used in the system.

The log reduction unit S204 performs reduction of the contents of the logs collected in a predetermined period by kinds of logs, and reduces the amount of data to be transmitted by the transmission unit S205 through the log reduction.

The transmission unit S205 transmits the reduced intrusion detection logs to the control intermediate management servers, and transmits the intrusion detection log information which has been reduced for a predetermined period and whose form has been converted.

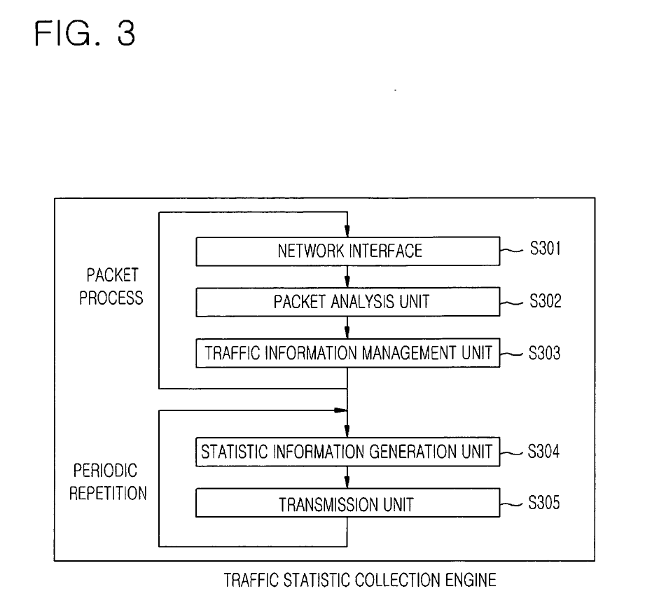

FIG. 3 is a view illustrating the internal construction of a traffic statistic generation engine according to an embodiment of the present invention.

In FIG. 3, a process of generating and transmitting traffic statistic information, which is performed by the traffic statistic generation engine 102, is illustrated. For this, the traffic statistic generation engine includes a packet analysis unit S302, a traffic information management unit S303, a statistic information generation unit S304, and a transmission unit S305.

The packet analysis unit S302 serves to analyze header information of packets collected from the network interface S301.

The traffic information management unit S303 serves to store and manage packet information that has been analyzed for a predetermined time in a database or a memory, and after the user of the corresponding information is completed, it deletes the information. The packet analysis unit S302 and the traffic information management unit S303 performs their operations whenever a packet is captured from the network interface S301.

The statistic information generation unit S304 generates statistic information on the packet information collected for the predetermined period. The statistic information includes the number of input/output packets, the number of input/output bytes, traffic statistics by ports, traffic statistics by protocols, traffic statistics by sizes, traffic statistics by source IPs, and traffic statistics by destination IPs.

The transmission unit S305 serves to transmit the statistic information generated from the statistic information generation unit S304 for a predetermined period to the control intermediate management servers.

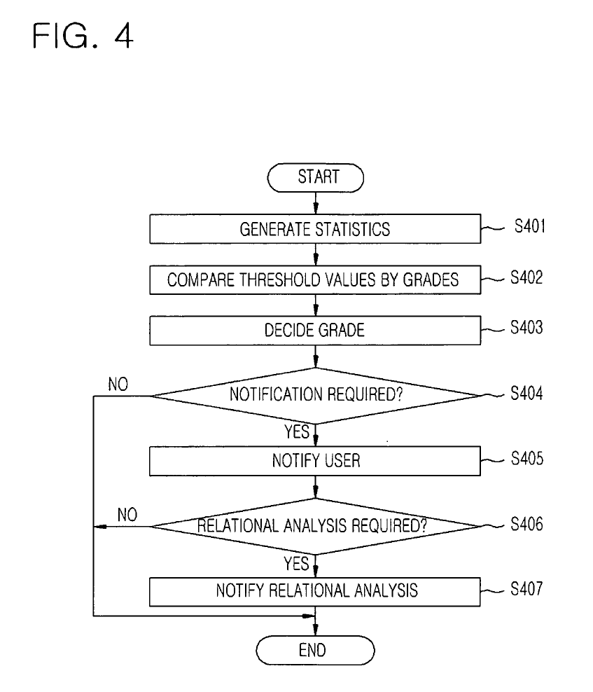

FIG. 4 is a flowchart illustrating a process performed by intrusion detection analysis units and traffic analysis units of a control intermediate management server and a control uppermost management server according to an embodiment of the present invention.

In FIG. 4, an analysis process, which is performed by the intrusion detection analysis units 201 and 301 and the traffic analysis units 202 and 302 of the control intermediate management server 200 and the control uppermost management server 300, is illustrated.

The analysis process performed by the intrusion detection analysis units and the traffic analysis units of the control intermediate management server and the control uppermost management server is a threshold-based grade decision process. The intrusion detection analysis unit performs the analysis using the collected intrusion detection log information, and the traffic analysis unit performs the analysis using the collected traffic statistic information.

The analysis unit generates the statistic information on the information collected for the predetermined period (S401), and compares the generated statistic information with a threshold value generated in the initial operation process (S402). The threshold values are diversely set by grades of risk, and can be manually adjusted by a manager. The analysis unit decides the grade to which the generated statistics belong through the threshold value comparison by grades (S403), and if the decided grade is a grade that requires the notification to the user (S404), the analysis unit notifies the manager of the result of individual analysis through a management console or the uppermost management console (S405). Also, if the decided grade is a grade that requires the relational analysis (S406), the analysis unit notifies the relational analysis unit that the relational analysis is required (S407) to perform the relational analysis. If the decided grade is a grade that does not require the notification to the user, the analysis unit is in a standby state until the next analysis time.

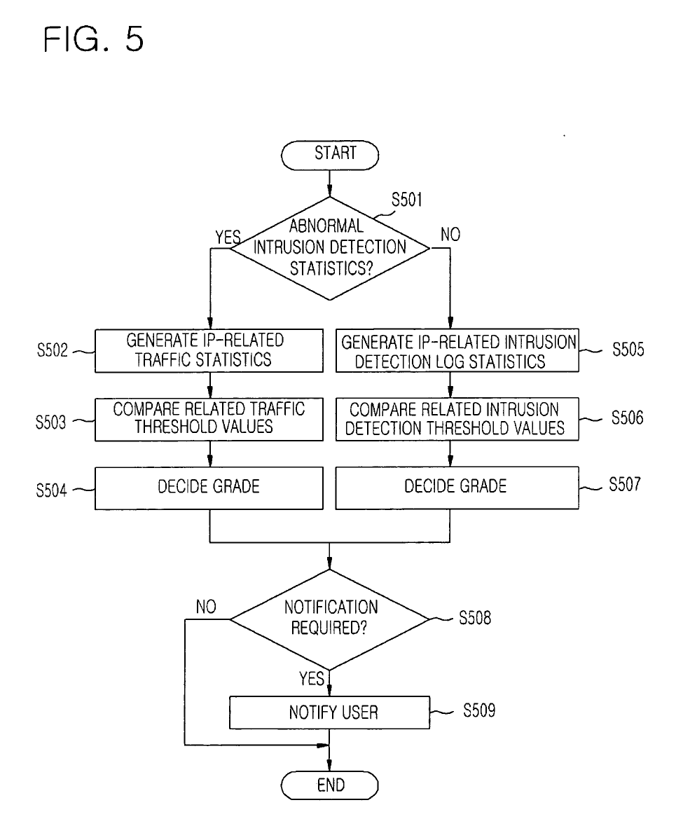

FIG. 5 is a flowchart illustrating a process performed by relational analysis units of a control intermediate management server and a control uppermost management server according to an embodiment of the present invention.

In FIG. 5, a relational analysis process, which is performed by the relational analysis units of the control intermediate management server and the control uppermost management server, is illustrated.

The relational analysis unit operates when the intrusion detection analysis unit or the traffic analysis unit notifies that the relational analysis is required, and decides whether the intrusion detection statistic information or the traffic statistic information is abnormal (S501). If the intrusion detection statistic information is abnormal, the relational analysis unit generates the traffic statistic information of the related IP (S502), and decides the grade of relational analysis of the intrusion detection statistics and the traffic statistics (S504) through the comparison with the relational traffic threshold value (S503). If the traffic statistic information is abnormal, the relational analysis unit generates the intrusion detection log statistic information including the related IP that causes the abnormality of the traffic statistics (S505), and decides the grade of relational analysis of the traffic statistics and the intrusion detection statistics (S507) through the comparison with the relational intrusion detection threshold value (S506). If it is required to notify the user of the decided grade (S508), the relational analysis unit notifies the user of the decided grade through the management console or the uppermost management console (S509).

According to the multistep integrated security management system and method using the intrusion detection log collection engine and the traffic statistic generation engine, the grade of risk is decided by individually analyzing the intrusion detection log information collected by the intrusion detection log collection engine and the traffic statistic information collected by the traffic statistic generation engine, and if the actual relational analysis is required, the intrusion is decided through the relational analysis of the intrusion detection log information and the traffic statistic information. In addition, by constituting a management server as a multistep hierarchical structure, the present invention can be applied to several independent large-scale means.

As described above, according to the multistep integrated security management system and method using the intrusion detection log collection engine and the traffic statistic generation engine, the intrusion detection information collected by the intrusion detection log collection engine and the traffic statistics generated by the traffic statistic generation engine are relationally analyzed, and thus the manager can be notified of any meaningful intrusion event. The system and method according to the present invention can reduce the misdetection rate, and overcome the limitations of detection against a new type attack by an intrusion detection pattern, and the limitations of detection against the attack having a small change of traffic. In particular, the attack, which cannot be detected by the traffic statistics, can be detected by the pattern-based detection, and the attack, which cannot be detected by the pattern-based detection, can be detected by the detection by the traffic statistics. Since the multistep integrated security management system and method according to the present invention can take both the advantage of the pattern-based detection and the advantage of the detection by the traffic statistics, the misdetection of the control system can be reduced, and the actual meaningful information can be effectively provided to the manager.

In addition, the multistep integrated security management system and method according to the present invention can support a multistep structure for controlling plural independent large-scale means.

While the multistep integrated security management system and method according to the present invention has been described and illustrated herein with reference to the preferred embodiment thereof, it will be understood by those skilled in the art that various changes of the modifications may be made to the invention without departing from the spirit and scope of the invention, which is defined in the appended claims.

What is claimed is:

1. A multistep integrated security management system using an intrusion detection log collection engine and a traffic statistic generation engine, the system comprising:
control agents provided for respective means that use independent networks, and each being composed of the intrusion detection log collection engine for collecting intrusion detection logs and the traffic statistic generation engine for generating traffic statistics; and
a management server for individually or relationally analyzing the intrusion detection logs and the traffic statistics transferred from the respective control agents, and integrally or relationally analyzing intrusion detection log information and traffic statistic information that are results of the individual or relational analysis.

2. The system as claimed in claim 1, wherein the intrusion detection log collection engine comprises:
an external interface unit for accessing to an intrusion detection system in order to collect the intrusion detection logs;
a form conversion unit for converting the collected intrusion detection logs into a form that is used in the corresponding system;
a log reduction unit for performing reduction of contents of the logs collected in a predetermined period by kinds of logs; and
a transmission unit for transmitting the reduced logs to the management server.

3. The system as claimed in claim 2, wherein the traffic statistic generation engine comprises:
a network interface for connecting to a network;
a packet analysis unit for analyzing header information of packets collected from the network interface;
a traffic information management unit for storing and managing packet information analyzed for a predetermined time in a database or a memory, and after the user of the corresponding information is completed, deleting the information;
a statistic information generation unit for generating statistic information on the packet information collected for a predetermined period; and
a transmission unit for transmitting the statistic information generated for the predetermined period to the management server.

4. The system as claimed in claim 3, wherein the statistic information includes the number of input/output packets, the number of input/output bytes, traffic statistics by ports, traffic statistics by protocols, traffic statistics by sizes, traffic statistics by source IPs, and traffic statistics by destination IPs.

5. The system as claimed in claim 3, wherein the management server comprises:
a plurality of control intermediate management server for individually or relationally analyzing the intrusion detection logs and the traffic statistics transferred from the respective control agents; and
a control uppermost management server for integrally or relationally analyzing the intrusion detection log information and the traffic statistic information transferred from the plurality of control intermediate management server.

6. The system as claimed in claim 5, wherein the control intermediate management server comprises:
an intrusion detection analysis unit for individually analyzing the intrusion detection information collected by the intrusion detection log collection engine of the respective control agent, notifying the result of analysis through a management console if it is required to notify a user of the result of analysis, and notifying a relational analysis unit of an analysis performing if a relational analysis is required;
a traffic analysis unit for individually analyzing the traffic statistic information collected by the traffic statistic generation engines, notifying the result of analysis through a management console if it is required to notify the user of the result of analysis, and notifying a relational analysis unit of an analysis performing if a relational analysis is required;
a relational analysis unit for performing a relational analysis of the intrusion detection information and the traffic statistic information using the intrusion detection log information and the traffic statistic information, with respect to the relational analysis performing notified by the intrusion detection analysis unit and the traffic analysis unit; and
a management console for providing diverse visualization of the user notification information and the information generated by the intrusion detection analysis unit, the traffic analysis unit, and the relational analysis unit.

7. The system as claimed in claim 5, wherein the control uppermost management server comprises:
an intrusion detection analysis unit for individually analyzing the intrusion detection information transferred from the respective control intermediate management servers, notifying the result of analysis through an uppermost management console if it is required to notify a user of the result of analysis, and notifying a relational analysis unit of an analysis performing if a relational analysis is required;
a traffic analysis unit for individually analyzing the traffic statistic information transferred from the respective control intermediate management servers, notifying the result of analysis through the uppermost management console if it is required to notify the user of the result of analysis, and notifying a relational analysis unit of an analysis performing if a relational analysis is required;
a relational analysis unit for performing a relational analysis of the intrusion detection information and the traffic statistic information using the intrusion detection log information and the traffic statistic information, with respect to the relational analysis performing notified by the intrusion detection analysis unit and the traffic analysis unit;
the uppermost management console for providing diverse visualization of the user notification information and the information generated by the intrusion detection analysis unit, the traffic analysis unit, and the relational analysis unit; and
an extended interface for supporting a connection with an upper analysis system of the control uppermost management server.

8. A multistep integrated security management method using an intrusion detection log collection engine and a traffic statistic generation engine, the method comprising the steps of:
the intrusion detection log collection engine collecting intrusion detection logs and the traffic statistic generation engine collecting traffic statistics, for each control agent;
transferring the intrusion detection logs and the traffic statistics to control intermediate management servers, and the control intermediate management servers performing individual analysis, and performing relational analysis if the relational analysis is required; and
transferring intrusion detection log information and traffic statistic information that are results of the analysis to a control uppermost management server, and the control uppermost management server performing integrated analysis including individual analysis, and performing relational analysis if the relational analysis is required.

9. The method as claimed in claim 8, wherein the control uppermost management server transfers the result of process to another control management server, and the control management server processes the intrusion detection log information and the traffic statistic information.

10. The method as claimed in claim 8, wherein the relational analysis is performed using either of a method of performing the relational analysis using the traffic statistic information including a log-related IP for a corresponding period if the intrusion detection log statistics are found abnormal, and a method of performing the relational analysis using the intrusion detection log statistics for a corresponding period if the traffic statistics are found abnormal.
